(19) United States
(12) Patent Application Publication
(10) Pub. No.: US 2008/0254700 A1
(43) Pub. Date: Oct. 16, 2008

(54) PROCESS FOR MAKING FIBROUS BOARD

(76) Inventor: Garry E. Balthes, Lowell, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/100,903

(22) Filed: Apr. 10, 2008

Related U.S. Application Data
(60) Provisional application No. 60/911,157, filed on Apr. 11, 2007.

(51) Int. Cl. B32B 5/24

(52) U.S. Cl. 442/374

(57) ABSTRACT

An improved process for more economically and efficiently making a fibrous article optionally including one or more functional components includes steps of providing a fibrous body comprising natural fibers, synthetic fibers, glass fibers or a combination of these fibers; generating a foam comprising a continuous liquid phase and a dispersed gaseous phase; and impregnating the fibrous body with the foam by applying the foam to at least one surface of the fibrous body.

### CROSS-REFERENCE TO RELATED APPLICATION

This application claims, under 35 U.S.C. §119(e), the benefit of U.S. Provisional Application No. 60/911,157 filed on Apr. 11, 2007 the entire disclosure of which is incorporated herein by reference.

### FIELD OF THE INVENTION

This invention relates to fibrous structures and more particularly to a process for making fibrous structures exhibiting improved strength, rigidity, and optional functional characteristics.

### BACKGROUND OF THE INVENTION

Various fibrous composites comprised of synthetic fibers, natural fibers, glass fibers or a combination thereof, combined with a binder and a functional component, such as a fire-retardant, have been used or at least proposed for use in making automotive components, furniture components, packaging, appliance components, home and industrial building construction, etc.

However, more efficient and economical processes for achieving more uniform dispersion of the binders and/or optional functional components throughout the fibrous mass, and more thorough impregnation or coverage of the individual fibers in fibrous mass is desirable.

### SUMMARY OF THE INVENTION

The invention provides an improved process for more economically and efficiently making a fibrous article optionally including one or more functional components, and the resulting fibrous article. The process includes steps of providing a fibrous body of natural fibers, synthetic fibers, glass fibers or a combination of these fibers; generating a foam chemistry blend having a continuous liquid phase and a dispersed gaseous phase; and impregnating the fibrous body with the foam by pressure injecting the foam to one or both surfaces of the fibrous body.

These and other features, advantages and objects of the present invention will be further understood and appreciated by those skilled in the art by reference to the following specification, claims and appended drawings.

### BRIEF DESCRIPTION OF THE DRAWING

FIG. 1 is a process flow diagraph illustrating the steps used in making a fibrous board having functional characteristics in accordance with a particular embodiment of the invention.

### DETAILED DESCRIPTION OF PREFERRED EMBODIMENTS

In accordance with all embodiments of the invention, a fibrous article is prepared by impregnating a fibrous body with a foam in order to uniformly and thoroughly distribute binders and/or functional components in the foam throughout the fibrous body.

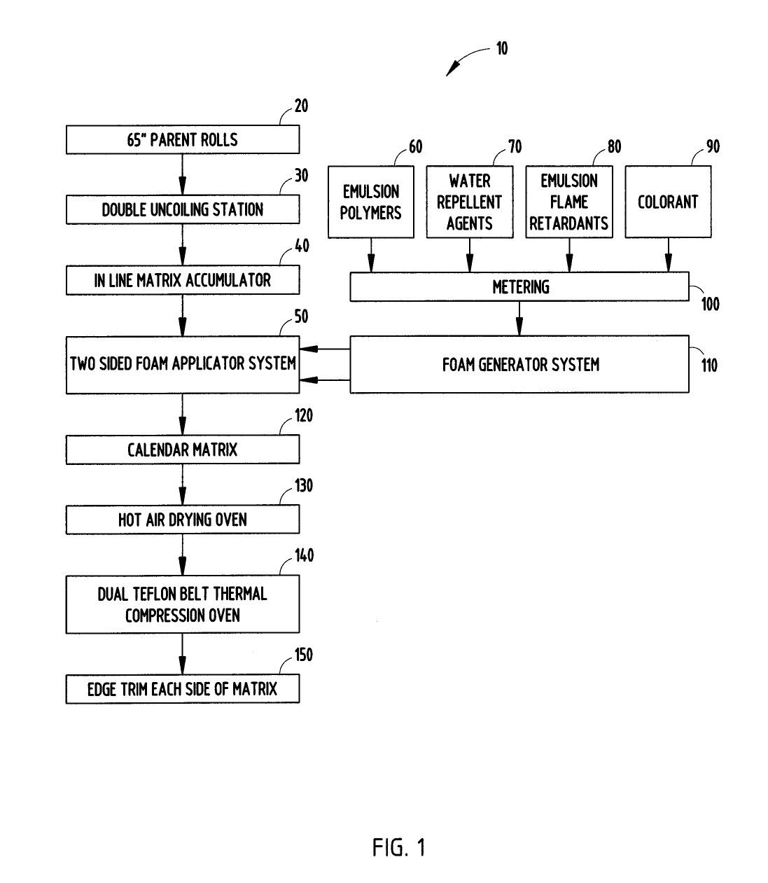

In FIG. 1, there is shown a process flow diagram illustrating the steps used for making a fibrous board having functional characteristics in accordance with certain embodiments of the invention. In a first step 20 of process 10, parent rolls consisting of 80 to 100% natural fiber and 0 to 20% crimped polymer fiber are provided. Examples of natural fibers that may be utilized include kenaf, hemp, jute, tossa, curaua and rayon fibers. Examples of suitable synthetic fibers include polyester, polyethylene, nylon and polypropylene. In a second step 30, the parent rolls are loaded into uncoiling systems, such as a double uncoiling station, which allows uninterrupted operation. In a third step 40, the uncoiled material from the parent rolls is fed to an in-line matrix accumulator that allows the line to run continuously while rolls are being changed out. Such accumulators typically have a total accumulation capacity of up to about 3 minutes at 8 meters per minute line speed. From the accumulator, the material from the parent rolls is conveyed to a two-sided foam applicator system in step 50. The foam can be applied to either or both sides of the material from the parent rolls. When foam is applied to both sides of the material, the foam may be applied to each side simultaneously or sequentially. The foam is prepared by providing polymers 60, optional water-repellant agents 70, optional flame retardants 80, and/or optional colorants 90, which may be combined in a metering and blending step 100. Examples of suitable emulsion polymers include acrylic copolymers, polyurethanes, polyesters, and polypropylene. Examples of water-repellant agents that may be used include fluoropolymers, polysilanes, and polysiloxanes. Examples of flame retardants that may be used include ammonium phosphate, sodium borate, etc. The metered and blended polymer or polymers, optional water-repellant agents, optional flame retardants, and/or optional colorants are delivered to a foam generator system 110, wherein the metered and blended materials are combined with air or other gas to form a foam used in step 50. Material exiting the foam applicator may be calendared in step 120, to pre-compress the foamed material prior to entering a drying oven. In a drying step 130, the foam material may be conveyed to a hot air drying oven. A dual belt hot air drying oven having 10 zones, each one meter in length, and having reversible air flow (top down and bottom up) may be used. The air oven can be used to dry the foamed material to a moisture content that is, for example, less than 1% by weight. In a step 140, the dried, foamed material may be compressed, such as in a dual Teflon belt thermal compression oven having, for example, a 3 meter heating zone and a 7 meter cooling zone. The belt oven sets the final compression thickness and may be used to provide a smooth surface, and to finalize cross-linking of thermosettable resins, when such resins are employed in the foam. Finally, it is desirable to trim the edges of the material in step 150 to remove any untreated matrix. For example, about 2.5 inches may be trimmed from each side.

A first step in the processes of the invention involves providing a fibrous body comprising natural fibers, synthetic fibers, glass fibers or a combination of these fibers. The fibers may be randomly oriented, preferentially oriented in a particular direction (e.g., vertically lapped), or woven. In addition, the fibrous body may be optionally treated, such as by needle punching, basting, crimping or the like. The fibrous body may be provided in any of a variety of forms, such as sheets or rolls. However, in order to facilitate continuous high speed production, it is desirable that the fibrous body be provided in the form of relatively wide rolls (e.g., 65 inches) that may be uncoiled and connected end-to-end, such as by stitching or the like to provide a continuous, uninterrupted, stream of fibrous material to the foam applicator.

Natural fibers that may be employed in the process for making fiber structures in accordance with the invention include kenaf, hemp, jute, tossa, curaua, roselle, aramina and rayon. The fibrous bodies used in preparing the fibrous articles of the invention may comprise over 50% natural fibers, and more desirably at least 80% natural fibers by weight based on the total weight of all fibers in the fibrous body. Synthetic fibers which may be used in preparing the fibrous bodies used in this invention include polyester fibers, such as polyethylene terephthalate (PET) fibers, polyethylene fibers, nylon fibers and polypropylene fibers. Desirably, crimped synthetic or polymer fibers are employed in an amount of up to about 20% by weight based on the total weight of all fibers in the fibrous body. Mineral fibers, such as glass fibers, may be employed if desired, typically in relatively low amounts.

The fibrous body is impregnated with a foam having a liquid phase comprising a thermosettable or thermoplastic resin binder material and optionally containing a functional agent. Examples of functional agents which may be employed include water-repellant agents, flame-retardant agents, and coloring agents. A foam applicator comprising a foam generator in which a gas and liquids are mixed and discharged in the form of a foam under pressure is employed for dispersing binders and/or functional agents uniformly throughout the fibrous mass. Suitable foam applicators are commercially available and are described in the literature such as in U.S. Pat. No. 6,508,882.

The extent to which the foam penetrates the fibrous body may controlled by suitably adjusting pressure of the foam impinging directly from an injection nozzle onto surface of the fibrous body and/or the relative rate of speed of the fibrous body with respect to the nozzles during pressure injection of the foam. Suitable speeds typically range from about 1 to about 7 meters per minute, and suitable pressures typically range from about 1 to about 7 psi.

The liquid phase used to generate the foam may comprise at least one binder resin which may be in the foam of a thermosettable liquid or a thermoplastic or thermosettable particulate or powder uniformly dispersed in the liquid. Examples of thermosettable resins that may be employed include thermo settable acrylic copolymers, vinyl ester resins, vinyl acetate copolymers, epoxy resins, urethane prepolymers, amino resins, bismaleimides and unsaturated polyesters. Other thermosettable resin binders that may be employed include phenol-formaldehyde, urea-formaldehyde, melamine-formaldehyde, and the like. Examples of suitable thermoplastic binders that may be distributed in the liquid phase in the form of fine particulates or powders include polyolefins such as polyethylene and polypropylene, ethylene-ethyl acetate copolymer, ethylene-vinyl copolymer, and the like. More than one binder agent can be combined into one mix when chemical compatibility exists between binding agents such as combining a singular epoxy resin with an epoxy polyester resin.

The liquid phase of the foam is typically in the form of an aqueous emulsion comprising a water-phase, an organic phase, and one or more surfactants. Suitable surfactants include alkyl sulfonates, alkylaryl sulfonates, alkyl sulfates, sulfates of hydroxylalkanols, alkyl and alkylaryl disulfonates, sulfonated fatty acids, sulfates and phosphates of polyethoxylated alkanols and alkyl phenols, esters of sulfosuccinic acid, alkyl quaternary ammonium salts, alkyl quaternary phosphonium salts, ethylene oxide, propylene oxide, alkyl phenols, higher fatty acids, higher fatty acid amines, primary or secondary higher alkyl amines, and block copolymers of propylene oxide and ethylene oxides. As is known by those having ordinary skill in the art, such surfactants are selected to achieve a suitable dispersion of the organic phase in the aqueous phase in the case of an oil-in-water emulsion or to disperse the aqueous phase in an organic phase in the case of a water-in-oil emulsion, and to facilitate or enhance foaming.

In addition to the binders and surfactants, the liquid phase used to generate the foam that is impregnated into the fibrous body may and desirably does comprise one or more functional agents. Examples of functional agents that may be employed in the liquid phase include water-repellent agents, flame-retardants and coloring agents. Examples of water-repellent agents that may be employed include fluoropolymers (i.e., a polymer containing fluorine atoms) such as polytetrafluoroethylene (PTFE), ethylene tetrafluoroethylene (ETFE), polyvinylidene fluoride (PVDF), poly(chlorotrifluoroethylene) (CTFE), fluorinated ethylene propylene (FEP), and perfluoroalkoxy polymer resin (PFA). Other water-repellent agents that may be employed include silane and/or siloxane compounds. These materials may be present in the form of polymers (e.g., silicon oils) and/or in the form of condensable materials that polymerize in situ after application of the foam to the fibrous body via hydrolysis and condensation reactions, typically in the presence of a catalyst, such as an acid or base.

Colorants that may be employed include various pigments, clays, dyes and lakes.

The various components comprising the liquid phase used for generating the foam are metered and blended before being introduced to the foam generator, which combines the liquid phase with a gaseous phase to produce a foam that is applied under pressure to the fibrous body. Suitable gases that may be used for generating the foam include air, nitrogen, neon, argon, helium, or combinations of these gases. The ratio of gas:liquid on a weight basis in the foam is desirably from about 5:1 to about 15:1 depending on the density and thickness of the fibrous body. Denser and/or thicker fibrous bodies generally require a higher gas:liquid ratio.

In some cases, such as with relatively thin fibrous bodies, a desirably uniform distribution of binders and/or functional components may be achieved by applying the foam to one side or surface of the fibrous body. However, typically, it is more desirably to apply the foam to opposite sides of the fibrous body to achieve a thorough and uniform distribution of the binders and/or functional components throughout the fibrous mass. By appropriate selection of process parameters, including foam composition, foam application rate and pressure, it is possible to achieve relatively thorough and uniform distribution of binders and/or functional components throughout a fibrous body of generally any desired thickness (e.g., up to at least about 10 inches). Foam application can either be applied to either side of fibrous matrix using opposing or offset injection nozzles. In addition to uniform application of same chemistry each side, utilization of two independent foam generators further allows each side to be treated differently, included one side being impregnated with additional functional agents while the opposite side may contain a singular binding agent without other functional agents.

Optionally, after application of the foam to the fibrous body, the fibrous body may be calendared. Calendaring may be employed to further ensure uniform dispersion of the binders and/or functional components throughout the fibrous body, to pre-compress the fibrous body to a desired thickness, and/or to remove excess liquid. Calendaring rolls also provide the motion to pull fibrous matrix through the foam applicator.

After application of the foam to the fibrous body and after optional calendaring, the fibrous body is dried, typically in a hot air drying oven. Desirably, the fibrous body is dried to a moisture content that is less than 1% based on the weight of the impregnated fibrous body.

In certain applications, such as for flat panel type products requiring no further processing, it may be desirable to provide the fibrous structure with smooth surfaces. This can be achieved by passing the fibrous body through a dual Teflon belt thermocompression oven. The fibrous body is compressed between the Teflon belts while being heated to provide the fibrous body with smooth surfaces and to finalize cross-linking of thermoset resins.

In some cases, it may be difficult to achieve thorough and uniform distribution of binders and/or functional components at the edges of the fibrous body. In such cases, it is desirable to trim the edges of the fibrous body to remove untreated portions thereof.

In accordance with another aspect of the invention, the impregnated fibrous body, either before or after drying, may be further surface treated with another foam application to provide enhanced surface functionality, such as water repellency, flame-retardants, and/or color. The depth of penetration of the foam can be controlled by adjusting viscosity, the gas:liquid ratio and/or the application pressure. Typically, the viscosity range for the liquid phase of the foam is in the range from about 1,000 to about 4,000 centipoise, with lower viscosities (e.g., up to about 3,000 centipoise) being used for complete penetration throughout the fibrous mass and higher viscosities (e.g., 3,000-4,000 centipoise) being used for surface applications. As previously stated, a suitable gas:liquid ratio for the initial foam application to achieve a thorough and uniform distribution of binders and/or functional components throughout the fibrous body is from about 5:1 to about 15:1. For surface applications, the gas:liquid ratio is typically from about 15:1 to about 20:1. Suitable application pressures range from about 1 to about 14 bar (1 bar is approximately equal to 1 atmosphere or 14.7 psi), with higher pressures typically being used for achieving the initial penetration of foam throughout the fibrous body, and lower pressures being used for surface applications. During the initial foam application on one or both sides, typically sequentially, 100% saturation is desired (i.e., all fiber surfaces are wetted by the liquid component of the foam). Typically, the liquid component of the foam comprises from about 25% to about 60% solids on a weight basis.

In some cases, the fibrous body may be shaped after application of the foam and before or after drying.

The fibrous articles prepared in accordance to the processes of this invention may be utilized in the manufacture of various automotive components (automobile headliners, trunk liners, door panels and the like), building products (exterior siding, ceiling tiles, interior wall panels), aircraft interior components, modular housing components, office furniture, recreational vehicle products, etc.

The products prepared in accordance with the processes of the invention provide fibrous articles that may exhibit novelty with respect to uniformity of materials distributed through the fibrous article, uniformity of properties throughout the fibrous article, complete impregnation of the fibrous article by the binders and/or functional components, with resulting improvements in strength, rigidity, flame-retardancy and water-repellency.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A process for making a fibrous article, comprising steps of:
providing a fibrous body comprising natural fibers, synthetic fibers, glass fibers or a combination of these fibers;
generating a foam comprising a continuous liquid phase and a dispersed gaseous phase; and
impregnating the fibrous body with the foam by applying the foam to at least one surface of the fibrous body.

2. The process of claim 1, wherein the fibrous body is comprised of natural fibers selected from kenaf, hemp, jute, tossa, curaua and rayon.

3. The process of claim 1, wherein the fibrous body is comprised of synthetic fibers selected from polyester, polyethylene, nylon and polypropylene.

4. The process of claim 1, wherein the liquid phase used to generate the foam comprises a thermosettable resin selected from acrylic copolymers, poly urethanes, epoxy resins and vinyl ether resins.

5. The process of claim 1, wherein the liquid phase used to generate the foam comprises polypropylene.

6. The process of claim 1, wherein the fibrous body comprises at least 80% natural fibers by weight prior to being impregnated with the foam.

7. The process of claim 1, wherein the step of impregnating the fibrous body with the foam including applying the foam to opposite sides of the fibrous body.

8. The process of claim 7, wherein the foam is applied to one side of the fibrous body at a time.

9. The process of claim 1, wherein the liquid phase used to generate the foam comprises a water-repellent agent.

10. The process of claim 9, wherein the water-repellent agent is a fluoropolymer.

11. The process of claim 10, wherein the fluoropolymer is selected from polytetrafluoroethylene, ethylene tetrafluoroethylene, polyvinylidene fluoride, poly(chlorotrifluoroethylene), fluorinated ethylene propylene, and perfluoroalkoxy polymer resin.

12. The process of claim 9, wherein the water-repellent agent is a silane and/or siloxane compound.

13. The process of claim 1, further comprising compressing and/or shaping the impregnated fibrous body.

14. The process of claim 1, further comprising drying the impregnated fibrous body.

15. The process of claim 1, further comprising drying the impregnated fibrous body in a hot air oven.

16. The process of claim 15, in which heated air is used to dry the impregnated fibrous body to a moisture content of less than 1% by weight.

17. The process of claim 16, further comprising compressing the dried, impregnated fibrous body to provide a final compressed thickness and smooth surfaces.

18. The process of claim 16, wherein the liquid phase used to generate the foam comprises a thermosettable resin, and further comprising heating the dried, impregnated fibrous body during compression to cross-link the thermosettable resin.

19. The process of claim 1, further comprising trimming off edges of the impregnated fibrous body that are not impregnated.

20. The process of claim 1, in which the ratio of gas:liquid on a weight basis in the foam is from 5:1 to 15:1.

21. The process of claim 1, in which the gas used generate the foam is air, nitrogen, argon, helium, neon, or a combination of these gases.

22. The process of claim 1, in which all fibers in the fibrous mass are wetted by the impregnating foam.

23. The process of claim 1, further comprising a surface foam application that does not fully impregnate the fibrous body.

24. A fibrous article that is the product of the process of claim 1.
